(19) United States
(12) Patent Application Publication
(10) Pub. No.: US 2021/0220679 A1
(43) Pub. Date: Jul. 22, 2021

(54) FILTER-TYPE RESPIRATORY PROTECTIVE DEVICE

(71) Applicant: LASKO INTERNATIONAL LIMITED, Taoyuan City (TW)

(72) Inventor: Shih-Huang Liu, Taoyuan City (TW)

(21) Appl. No.: 17/013,937

(22) Filed: Sep. 8, 2020

(30) Foreign Application Priority Data
Jan. 20, 2020 (TW) 109200833

(51) Int. Cl. A62B 23/02; A62B 18/08

(52) U.S. Cl. CPC A62B 23/025; A62B 18/084

(57) ABSTRACT

The invention relates to a filter-type respiratory protective device which includes a facepiece, two ear loops and an air valve. The air valve is connected to the facepiece and provided with a partition to divide an internal cavity into a first chamber and a second chamber. The second chamber is formed with a perforation for connection to an external equipment. The air valve is configured to manage the exhaled air to flow unidirectionally from an interior space defined by the facepiece to the ambient through the first chamber.

### PRIORITY CLAIM

This application claims priority to R.O.C. Patent Application No. 109200833 filed Jan. 20, 2020, the entirety of which is incorporated herein by reference.

### FIELD OF THE INVENTION

The present invention relates to a filter-type respiratory protective device provided with separate inhalation and exhalation pathways.

### BACKGROUND OF THE INVENTION

Conventional face masks are typically designed to cover both of the nose and the mouth of a wearer through a single facepiece. The carbon dioxide-rich air exhaled by the wearer would tend to accumulate in the space between the face of the wearer and the face mask covering the nose and mouth of the wearer. When the wearer inhales, the oxygen-rich air passing through the filter material of the face mask from the ambient would mix with the exhaled air accumulated inside. As a result, the conventional face mask, while intended to filter out the airborne pollutants and harmful pathogens, would unfavorably reduce the oxygen content of the inhaled air and cause harm to human health.

### SUMMARY OF THE INVENTION

In order to address the drawbacks above, the invention provides a filter-type respiratory protective device with separate inhalation and exhalation pathways.

The filter-type respiratory protective device disclosed herein comprises:

a facepiece adapted to cover the nose and mouth of a wearer and formed with a through hole;

an ear loop portion connected to the facepiece; and

an air valve having a valve seat connected the facepiece in a manner corresponding to the through hole, a valve cap fixed to the valve seat, and a valve flap, wherein the valve seat is formed with a valve port arranged in fluid communication with an interior space defined by the facepiece, and wherein the valve cap defines together with the valve seat a cavity in fluid communication with the valve port and is provided with a partition to divide the cavity into a first chamber where a first positioning portion is disposed and a second chamber, the valve cap having a bottom wall formed with a plurality of exhaust ports and a surrounding wall formed with at least one perforation for connecting the second chamber to an external equipment, and wherein the valve flap mounted within the first chamber to cover the valve port and comprises a fixed portion fixed to the first positioning portion and a movable portion opposite to the fixed portion, the movable portion being adapted to move away from and open the valve port in response to an air flow, so that the air flow may enter the first chamber unidirectionally through the valve port and flow outwardly through the exhaust ports.

The air valve is configured to manage the exhaled air to flow unidirectionally from the interior space defined by the facepiece to the first chamber through the valve port and then exit the invented device to the ambient through the exhaust ports. As a result, the disadvantageous accumulation of the exhaled air in the facepiece is generally avoided, and the oxygen content of the inhaled air is increased significantly. The invention id adapted for combination with an external equipment, such as a negative ion generating unit or an air filter, so as to provide clean filtered air to the second chamber for the wearer to inhale.

### BRIEF DESCRIPTION OF THE DRAWINGS

The present invention will become more readily apparent to those ordinarily skilled in the art after reviewing the following detailed description and accompanying drawings, in which:

FIG. 1 is a perspective structural view of a filter-type respiratory protective device according to the invention;

FIG. 2 is a perspective structural view of an air valve according to the invention;

FIG. 3 is an exploded structural perspective view of the air valve according to the invention;

FIG. 4 is a cross-sectional structural view of the air valve according to the invention;

FIG. 5 is a schematic diagram of the filter-type respiratory protective device according to the invention during its use; and

FIG. 6 is another perspective structural view of the air valve according to the invention.

### DETAILED DESCRIPTION OF PREFERRED EMBODIMENTS

In order to facilitate the examiner's understanding of the technical features, content and advantages of the invention, as well as the desirable results achieved thereby, the invention will be described in detail as follows in the form of embodiments and with reference to the accompanying drawings. The drawings used herein are merely for the purpose of illustration, and may not be the true proportions and precise configurations after the implementation of the invention. Therefore, relationships between the proportions and configurations of the attached drawings should not be used to interpret or limit the scope of claims.

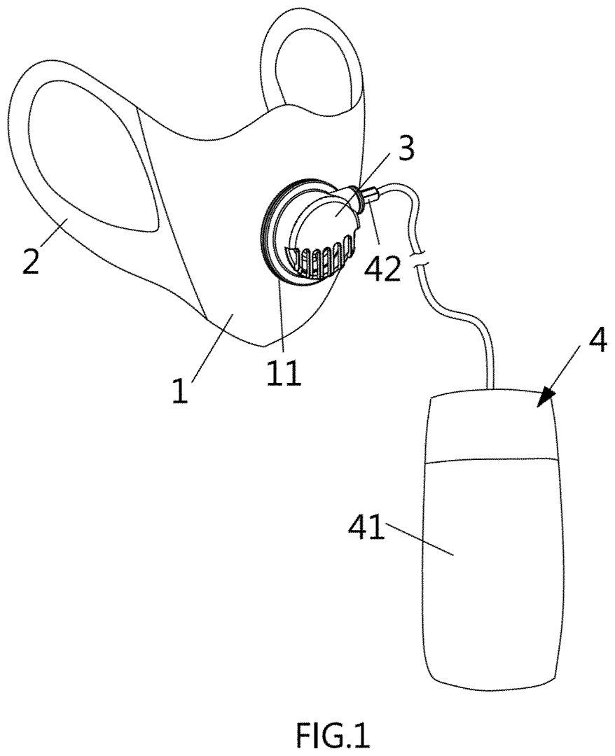

FIG. 1 is a perspective view showing an embodiment of a filter-type respiratory protective device according to the invention, which comprises a facepiece 1, an ear loop portion 2 and an air valve 3.

The facepiece 1 is configured to adapt to the contour of a human face and formed with a through hole 11. The facepiece 1 may be either in the form of an air-permeable filter body, or in the form of an air-impermeable body provided with an air-impermeable frame and a filter unit. In the embodiments described below, the facepiece 1 is illustrated by way of an example as an air-permeable body.

The ear loop portion 2 is connected to the facepiece 1. In the embodiments shown in the drawings, the ear loop portion 2 may include two ear loops connected to two opposite sides of the facepiece 1, respectively, allowing the facepiece 1 to be worn on the face. Alternatively, the ear loop portion 2 may include a single ear loop connected at two ends thereof to left and right sides of the facepiece 1, respectively.

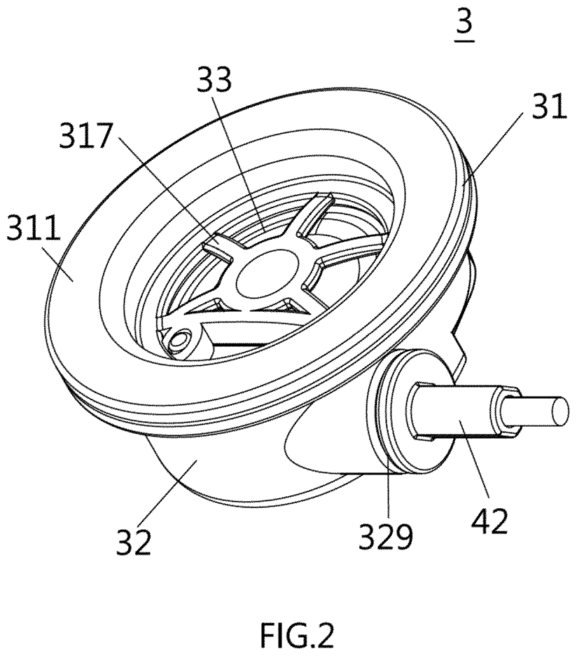

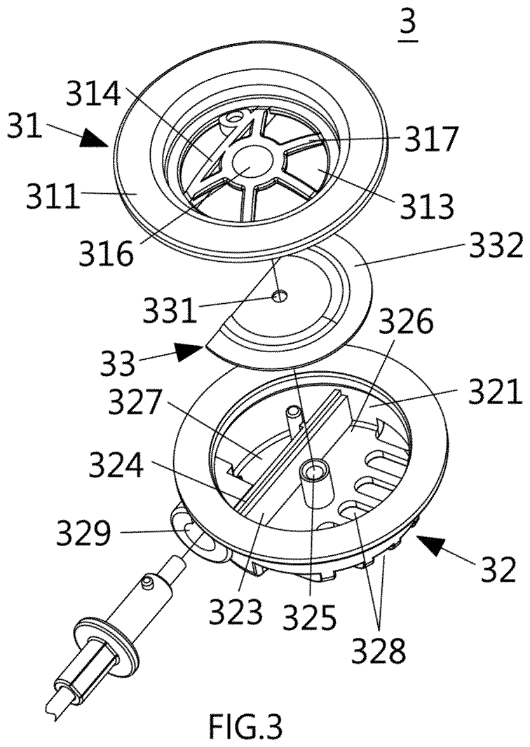

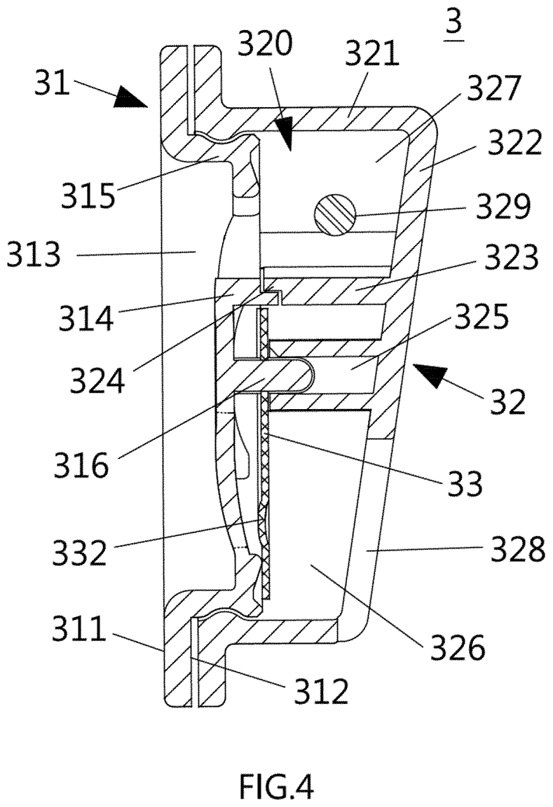

As shown in FIGS. 2 to 4, the air valve 3 may include a valve seat 31, a valve cap 32 and a valve flap 33. The valve seat 31 is connected the facepiece 1 in a manner corresponding to the through hole 11. The valve seat 31 may include an inner plate surface 311 facing toward the facepiece 1, an outer plate surface 312 arranged opposite to the inner plate surface 311, and a valve port 313 passing from the inner plate surface 311 to the outer plate surface 312 to correspond to the through hole 11, so that the valve port 313 is arranged in fluid communication with the interior space defined by the facepiece 1. The air valve 3 may further include a first engaging portion 314 traversing the valve port 313 along a lateral direction and corresponding to the through hole 11 of the facepiece 1, an annular wall 315 surrounding the valve port 313, a second positioning portion 316 connected to the first engaging portion 314, and a plurality of ribs 317 bridging the second positioning portion 316 and the annular wall 315. In the embodiments shown in the drawings, the first engaging portion 314 and the second positioning portion 316 may each include a projection protruding outwardly from the valve port 313.

The valve cap 32 is fixed to one side of the valve seat 31 and defines together with the valve seat 31 a cavity 320 in fluid communication with the valve port 313. The valve cap 32 may further include a surrounding wall 321 adapted to fit with the annular wall 315 of the valve seat 31, a bottom wall 322 adjoining one end of the surrounding wall 321, a partition 323 extending from the bottom wall 322 to define a second engaging portion 324 which corresponds to the first engaging portion 314, and a first positioning portion 325 extending from the bottom wall 322 in a manner corresponding to the second positioning portion 316. The cavity 320 is arranged in fluid communication with the valve port 313 of the valve seat 3 and the interior space defined by the facepiece 1, and it is divided into a first chamber 326 and a second chamber 327 by the partition 323. A plurality of exhaust ports 328 are formed on the bottom wall 322 and extend to the bottom wall 322, which allow the first chamber 326 to communicate with the ambient. The surrounding wall 321 of the valve cap 32 is formed with at least one perforation 329 corresponding to the second chamber 327, through which the device disclosed herein may be connected to an external equipment. According to the embodiments shown in the drawings, the first positioning portion 325 is configured to have a groove configuration for receiving the second positioning portion 316.

The valve flap 33 is an elastic membrane mounted within the first chamber 326 to cover the valve port 313 and arranged to lie on and comply in shape with the annular wall 315. The valve flap 33 comprises a fixed portion 331 held between the second positioning portion 316 of the valve seat 31 and the first positioning portion 325 of the valve cap 32, and a movable portion 332 formed at an end of the valve flap 33. The movable portion 332 is brought in contact with the annular wall 315 to generate a bending torque, thereby closing a lower half of the valve port 313. The movable portion 332 is adapted to move away from the annular wall 315 to open the valve port 313 in response to an air flow. The valve seat 31 and the valve cap 32 are assembled together by fitting the first engaging portion 314 to the second engaging portion 324, and fitting the first positioning portion 325 to the second positioning portion 316. The fixed portion 331 of the valve flap 33 is fixed between the valve seat 31 and the valve cap 32, such that the valve flap 33 only covers the lower half of the valve port 313, while an upper half of the valve port 313 is normally open. Preferably, the first and second engaging portions 314 and 324, as well as the first and second positioning portions 325 and 316, are configured complementary in shape to each other, e.g., in the form of a recess and a corresponding protrusion configurations, so that the valve seat 31 and the valve cap 32 may be assembled in a quick manner.

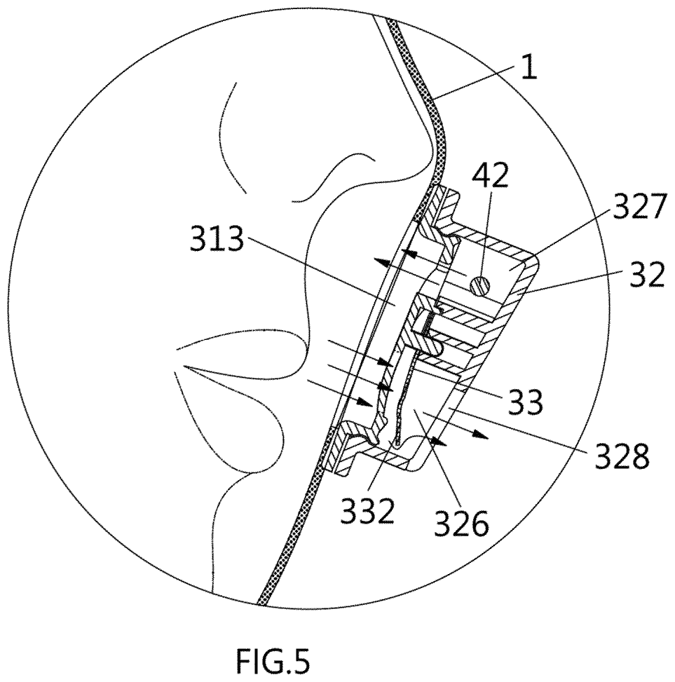

As shown in FIG. 5, when wearing the filter-type respiratory protective device, the wearer may put the ear loop portion 2 on his/her ears and fit the facepiece 1 to his/her face, with the air valve 3 positioned at the opposite side to the face of the wearer. When the wearer exhales with mouth or nose, the positive pressure generated during expiration pushes the movable portion 332 of the valve flap 33 away from the valve port 313 in the first chamber 326, so that the lower half of the valve port 313 is opened. As a result, the exhaled air enters the first chamber 326 unidirectionally through the lower half of the valve port 313 and flows towards the valve cover 32 where it is discharged outwardly through the exhaust ports 328 to reduce the pressure.

As shown in to FIG. 1, FIG. 2 and FIG. 5, the device disclosed herein may be connected with an external equipment through the perforation 329. The external equipment may be a portable air filter 4 having a main body 41, a detachable carbon fiber brush 42 and a power supply unit (not shown) electrically connected to the carbon fiber brush 42. The power supply unit is disposed within the main body 41, and the carbon fiber brush 42 is adapted for being inserted and fixed in the perforation 329. After being supplied with electric power, the carbon fiber brush 42 will release negative ions into the second chamber 327, and the negative ions will attach to floating particles and dusts in the air to form large particulates which will sediment afterwards, thereby preventing the particles and dusts from entering the human respiratory system to ensure that the air inhaled by the wearer is clean enough. The clean air will be supplied for inhalation through the upper half of the valve port 313. The detachable carbon fiber brush 42 is applicable not only to the portable air filter 4, but also to the filter-type respiratory protective device disclosed herein, in a bid to achieve the effect of air filtration.

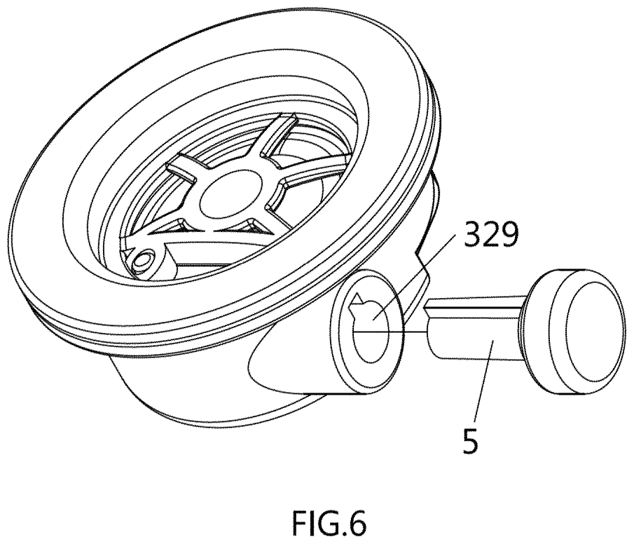

It is apparent to those skilled in the art that the external equipment may also be a negative ion generating unit. The negative ion generating unit has a carbon fiber brush and a power supply unit connected to the carbon fiber brush. The carbon fiber brush can be inserted and fixed in the perforation 329 to achieve the effect of air filtration. Alternatively, the external equipment is a plug 5 adapted to the perforation 329 as shown in FIG. 6, in the case where the filter-type respiratory protective device disclosed herein is to be used as a general face mask.

While the present invention has been described in detail herein, various modifications or changes within the spirit and scope of the present invention will be apparent to those skilled in the art. In view of the above disclosure, knowledge in the relevant art and the entire contents of documents discussed in the background and detailed description sections above are incorporated herein in their entirety for reference.

What is claimed is:

1. A filter-type respiratory protective device comprising:
a facepiece adapted to cover the nose and mouth of a wearer and formed with a through hole;
an ear loop portion connected to the facepiece; and
an air valve having a valve seat connected the facepiece in a manner corresponding to the through hole, a valve cap fixed to the valve seat, and a valve flap,
wherein the valve seat is formed with a valve port arranged in fluid communication with an interior space defined by the facepiece, and
wherein the valve cap defines together with the valve seat a cavity in fluid communication with the valve port and is provided with a partition to divide the cavity into a first chamber where a first positioning portion is disposed and a second chamber, the valve cap having a bottom wall formed with a plurality of exhaust ports and a surrounding wall formed with at least one perforation for connecting the second chamber to an external equipment, and
wherein the valve flap mounted within the first chamber to cover the valve port and comprises a fixed portion fixed to the first positioning portion and a movable portion opposite to the fixed portion, the movable portion being adapted to move away from and open the valve port in response to an air flow, so that the air flow may enter the first chamber unidirectionally through the valve port and flow outwardly through the exhaust ports.

2. The filter-type respiratory protective device as claimed in claim 1, wherein the external equipment is a negative ion generating unit comprising a carbon fiber brush and a power supply unit connected to the carbon fiber brush, with the carbon fiber brush being adapted for fixation within the perforation.

3. The filter-type respiratory protective device as claimed in claim 1, wherein the external equipment is a portable air filter comprising a main body, a detachable carbon fiber brush adapted for fixation within the perforation, and a power supply unit electrically connected to the carbon fiber brush and disposed in the main body.

4. The filter-type respiratory protective device as claimed in claim 1, wherein the external equipment is a plug.

5. The filter-type respiratory protective device as claimed in claim 1, wherein the valve seat comprises a second positioning portion fitted to the first positioning portion.

6. The filter-type respiratory protective device as claimed in claim 2, wherein the valve seat comprises a second positioning portion fitted to the first positioning portion.

7. The filter-type respiratory protective device as claimed in claim 3, wherein the valve seat comprises a second positioning portion fitted to the first positioning portion.

8. The filter-type respiratory protective device as claimed in claim 4, wherein the valve seat comprises a second positioning portion fitted to the first positioning portion.

9. The filter-type respiratory protective device as claimed in claim 1, wherein the valve seat comprises a first engaging portion fitted to a second engaging portion provided on the partition.

10. The filter-type respiratory protective device as claimed in claim 2, wherein the valve seat comprises a first engaging portion fitted to a second engaging portion provided on the partition.

11. The filter-type respiratory protective device as claimed in claim 3, wherein the valve seat comprises a first engaging portion fitted to a second engaging portion provided on the partition.

12. The filter-type respiratory protective device as claimed in claim 4, wherein the valve seat comprises a first engaging portion fitted to a second engaging portion provided on the partition.
